(19) United States
(12) Patent Application Publication
(10) Pub. No.: US 2021/0326708 A1
(43) Pub. Date: Oct. 21, 2021

(54) NEURAL NETWORK TRAINING METHOD AND APPARATUS, AND IMAGE PROCESSING METHOD AND APPARATUS

(71) Applicant: BEIJING SENSETIME TECHNOLOGY DEVELOPMENT CO., LTD., Beijing (CN)

(72) Inventors: Jiangfan HAN, Beijing (CN); Ping LUO, Beijing (CN); Xiaogang WANG, Beijing (CN)

(73) Assignee: BEIJING SENSETIME TECHNOLOGY DEVELOPMENT CO., LTD., Beijing (CN)

(21) Appl. No.: 17/364,731

(22) Filed: Jun. 30, 2021

Related U.S. Application Data
(63) Continuation of application No. PCT/CN2019/114470, filed on Oct. 30, 2019.

(30) Foreign Application Priority Data
May 21, 2019 (CN) 201910426010.4

(51) Int. Cl. G06N 3/08; G06K 9/62

(52) U.S. Cl. CPC G06N 3/08; G06K 9/6272; G06K 9/6232; G06K 9/6218; G06K 9/6215

(57) ABSTRACT

The present disclosure relates to a neural network training method and apparatus, and an image processing method and apparatus. The training method includes: performing classification processing on a target image in a training set by means of a neural network to obtain a prediction classification result of the target image; and training the neural network according to the prediction classification result, and an initial category tag and a corrected category tag of the target image. Embodiments of the present disclosure may supervise the training process of the neural network by means of the initial category tag and the corrected category tag, and simplify the training process and a network structure.

### CROSS-REFERENCE TO RELATED APPLICATIONS

The present application is a bypass continuation of and claims priority under 35 U.S.C. § 111(a) to PCT Application. No. PCT/CN2019/114470, filed on Oct. 30, 2019, which claims priority to Chinese Patent Application No. 201910426010.4, filed to the Chinese Intellectual Property Office on May 21, 2019 and entitled “NEURAL NETWORK TRAINING METHOD AND APPARATUS, AND IMAGE PROCESSING METHOD AND APPARATUS”, which is incorporated herein by reference in its entirety.

### TECHNICAL FIELD

The present disclosure relates to the technical field of computers, and in particular, to a neural network training method and apparatus, and an image processing method and apparatus.

### BACKGROUND

With the continuous development of artificial intelligence technology, machine learning (in particular, deep learning) achieves good effects in many fields, such as computer vision. Current machine learning (deep learning) has a strong dependence on large-scale precisely annotated datasets.

### SUMMARY

The present disclosure provides technical solutions for neural network training and image processing.

According to one aspect of the present disclosure, provided is a neural network training method, including: performing classification processing on a target image in a training set by means of a neural network to obtain a prediction classification result of the target image; and training the neural network according to the prediction classification result, and an initial category tag and a corrected category tag of the target image.

In one possible implementation, the neural network includes a feature extraction network and a classification network, the neural network includes N training states, and N is an integer greater than 1, where performing classification processing on the target image in the training set by means of the neural network to obtain the prediction classification result of the target image includes: performing feature extraction on the target image by means of the feature extraction network of an i^{th} state to obtain a first feature of the i^{th} state of the target image, where the i^{th} state is one of the N training states, and 0≤i<N; and performing classification on the first feature of the i^{th} state of the target image by means of the classification network of the i^{th} state to obtain a prediction classification result of the i^{th} state of the target image.

In one possible implementation, training the neural network according to the prediction classification result, and the initial category tag and the corrected category tag of the target image includes: determining an overall loss of the i^{th} state of the neural network according to the prediction classification result of the i^{th} state, the initial category tag of the target image, and the corrected category tag of the i^{th} state of the target image; and adjusting a network parameter of the neural network of the i^{th} state according to the overall loss of the i^{th} state to obtain the neural network of a (i+1)^{th} state.

In one possible implementation, the method further includes: performing feature extraction on a plurality of sample images of a k^{th} category in the training set by means of the feature extraction network of the i^{th} state to obtain a second feature of the i^{th} state of the plurality of sample images, where the k^{th} category is one of K categories of the sample images in the training set, and K is an integer greater than 1; performing clustering processing on the second feature of the i^{th} state of the plurality of sample images of the k^{th} category, and determining a class prototype feature of the i^{th} state of the k^{th} category; and determining the corrected category tag of the i^{th} state of the target image according to the class prototype feature of the i^{th} state of the K categories and the first feature of the i^{th} state of the target image.

In one possible implementation, determining the corrected category tag of the i^{th} state of the target image according to the class prototype feature of the i^{th} state of the K categories and the first feature of the i^{th} state of the target image includes: respectively acquiring a first feature similarity between the first feature of the i^{th} state of the target image and the class prototype feature of the i^{th} state of the K categories; and determining the corrected category tag of the i^{th} state of the target image according to the category to which the class prototype feature corresponding to a maximum value of the first feature similarity belongs.

In one possible implementation, the class prototype feature of the i^{th} state of each category includes a plurality of class prototype features, where respectively acquiring the first feature similarity between the first feature of the i^{th} state of the target image and the class prototype feature of the i^{th} state of the K categories includes: acquiring a second feature similarity between the first feature of the i^{th} state and the plurality of class prototype features of the i^{th} state of the k^{th} category; and determining the first feature similarity between the first feature of the i^{th} state and the class prototype feature of the i^{th} state of the k^{th} category according to the second feature similarity.

In one possible implementation, the class prototype feature of the i^{th} state of the k^{th} category includes a class center of the second feature of the i^{th} state of the plurality of sample images of the k^{th} category.

In one possible implementation, determining the overall loss of the i^{th} state of the neural network according to the prediction classification result of the i^{th} state, the initial category tag of the target image, and the corrected category tag of the i^{th} state of the target image includes: determining a first loss of the i^{th} state of the neural network according to the prediction classification result of the i^{th} state and the initial category tag of the target image; determining a second loss of the i^{th} state of the neural network according to the prediction classification result of the i^{th} state and the corrected category tag of the i^{th} state of the target image; and determining the overall loss of the i^{th} state of the neural network according to the first loss of the i^{th} state and the second loss of the i^{th} state.

According to another aspect of the present disclosure, provided is an image processing method, including: inputting an image to be processed into a neural network for classification processing to obtain an image classification result, where the neural network includes a neural network that is obtained by training according to the foregoing method.

According to another aspect of the present disclosure, provided is a neural network training apparatus, including: a prediction classification module, configured to perform classification processing on a target image in a training set by means of a neural network to obtain a prediction classification result of the target image; and a network training module, configured to train the neural network according to the prediction classification result, and an initial category tag and a corrected category tag of the target image.

In one possible implementation, the neural network includes a feature extraction network and a classification network; the neural network includes N training states, and N is an integer greater than 1, where the prediction classification module includes: a feature extraction submodule, configured to perform feature extraction on the target image by means of the feature extraction network of an i^{th} state to obtain a first feature of the i^{th} state of the target image, where the i^{th} state is one of the N training states, and 0≤i<N; and a result determination submodule, configured to perform classification on the first feature of the i^{th} state of the target image by means of the classification network of the i^{th} state to obtain a prediction classification result of the i^{th} state of the target image.

In one possible implementation, the network training module includes: a loss determination module, configured to determine an overall loss of the i^{th} state of the neural network according to the prediction classification result of the i^{th} state, the initial category tag of the target image, and the corrected category tag of the i^{th} state of the target image; and a parameter adjustment module, configured to adjust a network parameter of the neural network of the i^{th} state according to the overall loss of the i^{th} state to obtain the neural network of the (i+1)^{th} state.

In one possible implementation, the apparatus further includes: a sample feature extraction module, configured to perform feature extraction on a plurality of sample images of a k^{th} category in the training set by means of the feature extraction network of the i^{th} state to obtain a second feature of the i^{th} state of the plurality of sample images, where the k^{th} category is one of K categories of the sample images in the training set, and K is an integer greater than 1; a clustering module, configured to perform clustering processing on the second feature of the i^{th} state of the plurality of sample images of the k^{th} category, and determine a class prototype feature of the i^{th} state of the k^{th} category; and a tag determination module, configured to determine the corrected category tag of the i^{th} state of the target image according to the class prototype feature of the i^{th} state of the K categories and the first feature of the i^{th} state of the target image.

In one possible implementation, the tag determination module includes: a similarity acquisition submodule, configured to respectively acquire a first feature similarity between the first feature of the i^{th} state of the target image and the class prototype feature of the i^{th} state of the K categories; and a tag determination submodule, configured to determine the corrected category tag of the i^{th} state of the target image according to the category to which the class prototype feature corresponding to a maximum value of the first feature similarity belongs.

In one possible implementation, the class prototype feature of the i^{th} state of each category includes a plurality of class prototype features, where the similarity acquisition submodule is configured to: acquire a second feature similarity between the first feature of the i^{th} state and the plurality of class prototype features of the i^{th} state of the k^{th} category; and determine the first feature similarity between the first feature of the i^{th} state and the class prototype feature of the i^{th} state of the k^{th} category according to the second feature similarity.

In one possible implementation, the class prototype feature of the i^{th} state of the k^{th} category includes a class center of the second feature of the i^{th} state of the plurality of sample images of the k^{th} category.

In one possible implementation, the loss determination module includes: a first loss determination submodule, configured to determine a first loss of the i^{th} state of the neural network according to the prediction classification result of the i^{th} state and the initial category tag of the target image; a second loss determination submodule, configured to determine a second loss of the i^{th} state of the neural network according to the prediction classification result of the i^{th} state and the corrected category tag of the i^{th} state of the target image; and an overall loss determination submodule, configured to determine the overall loss of the i^{th} state of the neural network according to the first loss of the i^{th} state and the second loss of the i^{th} state.

According to another aspect of the present disclosure, provided is an image processing apparatus, including: an image classification module, configured to input an image to be processed into a neural network for classification processing to obtain an image classification result, where the neural network includes a neural network that is obtained by training according to the foregoing apparatus.

According to another aspect of the present disclosure, provided is an electronic device, including: a processor, and a memory configured to store a processor-executable instruction, where the processor is configured to invoke the instruction stored by the memory so as to execute the foregoing method.

According to another aspect of the present disclosure, provided is a computer readable storage medium having a computer program instruction stored thereon, where when the computer program instruction is executed by the processor, the foregoing method is implemented.

According to one aspect of the present disclosure, provided is a computer program, including a computer readable code, where when the computer readable code is run in the electronic device, a processor in the electronic device executes the foregoing method.

According to the embodiments of the present disclosure, the training process of the neural network is supervised by means of the initial category tag and the corrected category tag of the target image, and the optimization direction of the neural network is decided together, so that the training process and a network structure are simplified.

It should be understood that the foregoing general descriptions and the following detailed descriptions are merely exemplary and explanatory, but are not intended to limit the present disclosure. Other features and aspects of the present disclosure are described more clearly according to the detailed descriptions of the exemplary embodiments in the accompanying drawings.

### BRIEF DESCRIPTION OF THE DRAWINGS

The accompanying drawings here are incorporated into the specification and constitute a part of the specification. These accompanying drawings show embodiments that conform to the present disclosure, and are intended to describe the technical solutions in the present disclosure together with the specification.

FIG. 1 is a flowchart of a neural network training method according to embodiments of the present disclosure;

FIG. 2 is a schematic diagram of an application example of a neural network training method according to embodiments of the present disclosure;

FIG. 3 is a block diagram of a neural network training apparatus according to embodiments of the present disclosure;

FIG. 4 is a block diagram of an electronic device according to embodiments of the present disclosure; and

FIG. 5 is a block diagram of an electronic device according to embodiments of the present disclosure.

### DETAILED DESCRIPTION

The various exemplary embodiments, features, and aspects of the present disclosure are described below in detail with reference to the accompanying drawings. Same reference numerals in the accompanying drawings represent elements with same or similar functions. Although various aspects of the embodiments are illustrated in the accompanying drawings, the accompanying drawings are not necessarily drawn in proportion unless otherwise specified.

The special term “exemplary” here refers to “being used as an example, an embodiment, or an illustration”. Any embodiment described as “exemplary” here should not be explained as being more superior or better than other embodiments.

The term “and/or” herein only describes an association relation between associated objects, indicating that three relations may exist, for example, A and/or B may indicate three conditions, i.e., A exists separately, A and B exist at the same time, and B exists separately. In addition, the term “at least one” herein indicates any one of multiple listed items or any combination of at least two of multiple listed items. For example, including at least one of A, B, or C may indicate including any one or more elements selected from a set consisting of A, B, and C.

In addition, numerous details are given in the following detailed description for the purpose of better explaining the present disclosure. It should be understood by persons skilled in the art that the present disclosure can still be implemented even without some of those details. In some of the examples, methods, means, elements, and circuits that are well known to persons skilled in the art are not described in detail so that the principle of the present application becomes apparent.

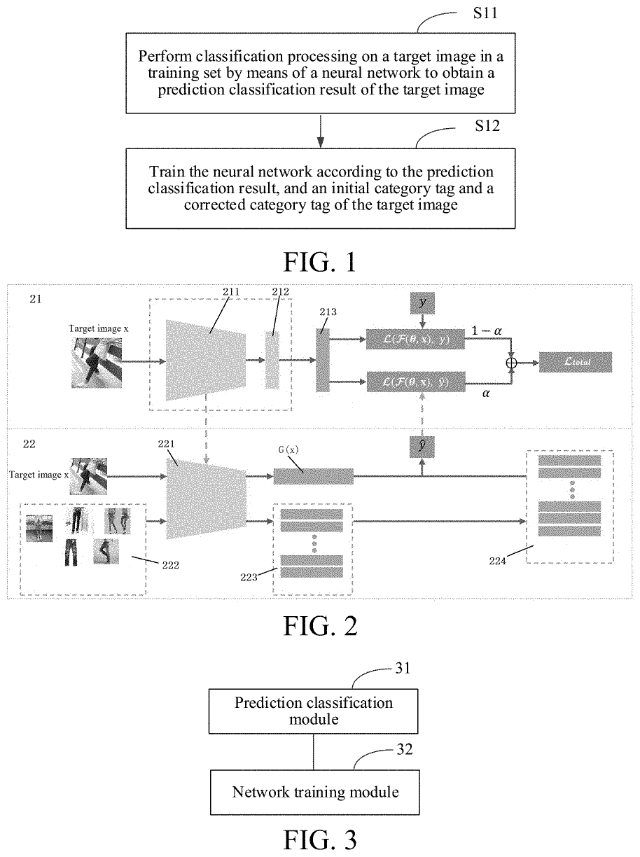

FIG. 1 is a flowchart of a neural network training method according to embodiments of the present disclosure. As shown in FIG. 1, the neural network training method includes the following steps.

At step S11, classification processing is performed on a target image in a training set by means of a neural network to obtain a prediction classification result of the target image.

At step S12, the neural network is trained according to the prediction classification result, and an initial category tag and a corrected category tag of the target image.

In one possible implementation, the neural network training method may be executed by an electronic device, such as a terminal device or a server. The terminal device may be User Equipment (UE), a mobile device, a user terminal, a terminal, a cellular phone, a cordless phone, a Personal Digital Assistant (PDA), a handheld device, a computing device, a vehicle-mounted device, and a wearable device, etc. The method may be implemented in the manner that the processor invokes a computer readable instruction stored in the memory. Alternatively, the method is executed by means of the server.

In one possible implementation, the training set may include a large number of sample images that are not precisely annotated. These sample images belong to different image categories. For example, the image categories are, for example, a face category (such as faces of different customers), an animal category (such as a cat and a dog), and a clothing category (such as a coat and trousers). The present disclosure does not limit the source and the specific category of the sample image.

In one possible implementation, each sample image has an initial category tag (a noise tag) configured to annotate the category to which the sample image belongs. However, since the sample images are not precisely annotated, there may be an error in the initial category tags of a certain number of sample images. The present disclosure does not limit the noise distribution situations of the initial category tags.

In one possible implementation, a neural network to be trained may, for example, be a deep convolutional network. The present disclosure does not limit the specific network type of the neural network.

In the process of training the neural network, at step S11, the target image in the training set is inputted into the neural network to be trained for classification processing to obtain the prediction classification result of the target image. The target images may be one or more of the sample images, e.g., the plurality of sample images of the same training batch. The prediction classification result may include a prediction category to which the target image belongs.

After the prediction classification result of the target image is obtained, at step S12, the neural network is trained according to the prediction classification result, and the initial category tag and the corrected category tag of the target image. The corrected category tag is used for correcting the category of the target image. That is, the network loss of the neural network is determined according to the prediction classification, the initial category tag, and the corrected category tag, and the network parameter of the neural network is reversely adjusted according to the network loss. The neural network that satisfies a training condition (such as network convergence) is finally obtained after numerous adjustments.

According to the embodiments of the present disclosure, the training process of the neural network is supervised by means of the initial category tag and the corrected category tag of the target image, and the optimization direction of the neural network is decided together, so that the training process and the network structure are simplified.

In one possible implementation, the neural network may include a feature extraction network and a classification network. The feature extraction network is configured to perform feature extraction on the target image, and the classification network is configured to perform classification on the target image according to an extracted feature to obtain a prediction classification result of the target image. The feature extraction network may, for example, include a plurality of convolutional layers. The classification network may, for example, include a fully-connected layer and a softmax layer, etc. The present disclosure does not limit the specific type and amount of the network layers of the feature extraction network and the classification network.

In the process of training the neural network, the network parameter of the neural network is adjusted many times. The neural network of next state may be obtained after the neural network of the current state is adjusted. The neural network may be set to include N training states, and N is an integer greater than 1. In this way, for the neural network of the current i^{th} state, step S11 may include:

performing feature extraction on the target image by means of the feature extraction network of the i^{th} state to obtain a first feature of the i^{th} state of the target image, where the i^{th} state is one of the N training states, and 0≤i<N; and

performing classification on the first feature of the i^{th} state of the target image by means of the classification network of the i^{th} state to obtain a prediction classification result of the i^{th} state of the target image.

That is, the target image may be inputted into the feature extraction network of the i^{th} state for feature extraction, and the first feature of the i^{th} state of the target image is outputted. The first feature of the i^{th} state is inputted into the classification network of the i^{th} state for classification, and the prediction classification result of the i^{th} state of the target image is outputted.

In this way, the output result of the neural network of the i^{th} state may be obtained, so that the neural network is trained according to the result.

In one optional implementation, the method further includes:

performing feature extraction on a plurality of sample images of the k^{th} category in the training set by means of the feature extraction network of the i^{th} state to obtain a second feature of the i^{th} state of the plurality of sample images, where the k^{th} category is one of K categories of the sample images in the training set, and K is an integer greater than 1;

performing clustering processing on the second feature of the i^{th} state of the plurality of sample images of the k^{th} category, and determining a class prototype feature of the i^{th} state of the k^{th} category; and

determining the corrected category tag of the i^{th} state of the target image according to the class prototype feature of the i^{th} state of the K categories and the first feature of the i^{th} state of the target image.

For example, the sample image in the training set may include K categories, and K is an integer greater than 1. The feature extraction network may be used as a feature extractor to extract the feature of each category of sample image. For the k^{th} category in the K categories (1≤k<K), some of the sample images (such as M sample images, where M is an integer greater than 1) may be selected from the sample images of the k^{th} category for feature extraction so as to reduce the calculation cost. It should be understood that feature extraction may be performed on all the sample images of the k^{th} category, which is not limited in the present disclosure.

In one possible implementation, M sample images may be randomly selected from the sample images of the k^{th} category, and the M sample images may also be selected in other manners (e.g., according to a parameter, such as image resolution), which is not limited in the present disclosure.

In one possible implementation, the M sample images of the k^{th} category may be respectively inputted into the feature extraction network of the i^{th} state for feature extraction, and the M second features of the i^{th} state of the M sample images are outputted, and then clustering processing is performed on the M second features of the i^{th} state so as to determine the class prototype feature of the i^{th} state of the k^{th} category.

In one possible implementation, clustering may be performed on the M second features in the manner, such as density peak clustering, K-means clustering, and spectral clustering. The present disclosure does not limit the clustering manner.

In one possible implementation, the class prototype feature of the i^{th} state of the k^{th} category includes a class center of the second features of the i^{th} state of the plurality of sample images of the k^{th} category. That is, the class center of the M second feature clusters of the i^{th} state may be taken as the class prototype feature of the i^{th} state of the k^{th} category.

In one possible implementation, there may be a plurality of class prototype features. That is, a plurality of class prototype features are selected from the M second features. For example, when the density peak clustering manner is adopted, the second features of p images with the maximum density value (p<M) may be selected as the class prototype features, and the class prototype feature may be selected according to comprehensive consideration of the parameters, such as a similarity measure between the density value and the feature. A person skilled in the art may select the class prototype feature according to actual situations, which is not limited in the present disclosure.

In this way, the feature that should be extracted from the sample in each category may be represented by the class prototype feature so as to be compared with the feature of the target image.

In one possible implementation, some sample images may be respectively selected from the sample images of the K categories, and the selected images are respectively inputted into the feature extraction network to obtain the second features. Each category of second features of is clustered to obtain each category of class prototype features. That is, the class prototype features of the i^{th} state of the K categories are obtained. Furthermore, the corrected category tag of the i^{th} state of the target image may be determined according to the class prototype feature of the i^{th} state of the K categories and the first feature of the i^{th} state of the target image.

In this way, the category tag of the target image may be corrected, and an additional supervisory signal is provided for training the neural network.

In one possible implementation, the step of determining the corrected category tag of the i^{th} state of the target image according to the class prototype feature of the i^{th} state of the K categories and the first feature of the i^{th} state of the target image may include:

respectively acquiring a first feature similarity between the first feature of the i^{th} state of the target image and the class prototype feature of the i^{th} state of the K categories; and

determining the corrected category tag of the i^{th} state of the target image according to the category to which the class prototype feature corresponding to a maximum value of the first feature similarity belongs.

For example, if the target image belongs to a certain category, the feature of the target image is highly similar to the feature (the class prototype feature) that should be extracted from the sample in the category. Therefore, the first feature similarity between the first feature of the i^{th} state of the target image and the class prototype feature of the i^{th} state of the K categories may be respectively calculated. The first feature similarity may, for example, be cosine similarity or Euclidean distance between the features, which is not limited in the present disclosure.

In one possible implementation, a maximum value in the first feature similarities of the K categories may be determined, and the category to which the class prototype feature corresponding to the maximum value belongs is determined as the corrected category tag of the i^{th} state of the target image. That is, the tag corresponding to the class prototype feature with the maximum similarity is selected to grant a new tag to the sample.

In this way, the category tag of the target image may be corrected by means of the class prototype feature so as to improve the accuracy of the corrected category tag; and the training effect of the network may be improved when the corrected category tag is adopted to supervise the training of the neural network.

In one possible implementation, the class prototype feature of the i^{th} state of each category includes a plurality of class prototype features, where the step of respectively acquiring the first feature similarity between the first feature of the i^{th} state of the target image and the class prototype feature of the i^{th} state of the K categories may include:

acquiring a second feature similarity between the first feature of the i^{th} state and the plurality of class prototype features of the i^{th} state of the k^{th} category; and

determining the first feature similarity between the first feature of the i^{th} state and the class prototype feature of the i^{th} state of the k^{th} category according to the second feature similarity.

For example, there may be a plurality of class prototype features, so that the feature that should be extracted from the sample in each category is represented more accurately. In this case, for any one of the K categories (the k^{th} category), the second feature similarities between the first feature of the i^{th} state and the plurality of class prototype features of the i^{th} state of the k^{th} category may be respectively calculated, and then the first feature similarity is determined according to the plurality of second feature similarities.

In one possible implementation, for example, the average value of the plurality of second feature similarities may be determined as the first feature similarity, and an appropriate similarity value may also be selected from the plurality of second feature similarities as the first feature similarity, which is not limited in the present disclosure.

In this way, the accuracy of the similarity calculation between the feature of the target image and the class prototype feature may be further improved.

In one possible implementation, after the corrected category tag of the i^{th} state of the target image is determined, the neural network may be trained according to the corrected category tag. Step S12 may include:

determining an overall loss of the i^{th} state of the neural network according to the prediction classification result of the i^{th} state, the initial category tag of the target image, and the corrected category tag of the i^{th} state of the target image; and

adjusting a network parameter of the neural network of the i^{th} state according to the overall loss of the i^{th} state to obtain the neural network of the (i+1)^{th} state.

For example, for the current i^{th} state, the overall loss of the i^{th} state of the neural network may be calculated according to the difference between the predication classification result of the i^{th} state obtained at step S11 and the initial category tag and the corrected category tag of the i^{th} state of the target image, and then according to the overall loss, the network parameter of the neural network is reversely adjusted to obtain the neural network of a next training state (the (i+1)^{th} state).

In one possible implementation, before the first training, the neural network is in the initial state (i=0), and the training of the network may be supervised only by using the initial category tag. That is, the overall loss of the neural network is determined according to the predication classification result of the initial state and the initial category tag, and then the network parameter is reversely adjusted to obtain the neural network of the next training state (i=1).

In one possible implementation, when i=N−1, according to the overall loss of the (N−1)^{th} state, the network parameter of the neural network of the i^{th} state is adjusted to obtain the neural network of the N^{th} state (network convergence). Therefore, the neural network of the N^{th} state may be determined as the trained neural network, and the whole training process of the neural network is completed.

In this way, the training process of the neural network may be completed in multiple cycles to obtain the high-precision neural network.

In one possible implementation, the step of determining the overall loss of the i^{th} state of the neural network according to the prediction classification result of the i^{th} state, the initial category tag of the target image, and the corrected category tag of the i^{th} state of the target image may include:

determining a first loss of the i^{th} state of the neural network according to the prediction classification result of the i^{th} state and the initial category tag of the target image;

determining a second loss of the i^{th} state of the neural network according to the prediction classification result of the i^{th} state and the corrected category tag of the i^{th} state of the target image; and

determining the overall loss of the i^{th} state of the neural network according to the first loss of the i^{th} state and the second loss of the i^{th} state.

For example, the first loss of the i^{th} state of the neural network may be determined according to the difference between the predication classification result of the i^{th} state and the initial category tag, and the second loss of the i^{th} state of the neural network is determined according to the difference between the predication classification result of the i^{th} state and the corrected category tag of the i^{th} state. The first loss and the second loss may, for example, be cross-entropy loss functions. The present disclosure does not limit the specific type of a loss function.

In one possible implementation, the weight sum of the first loss and the second loss is determined as the overall loss of the neural network. A person skilled in the art may set the weights of the first loss and the second loss according to actual conditions, which is not limited in the present disclosure.

In one possible implementation, the total loss Lₜₒₜₐₗ may be represented as:

Lₜₒₜₐₗ−(1−α)L(F(θ, x),y)+αL(F(θ, x), \hat{y}) (1)

In formula (1), x may represent the target image; θ may represent the network parameter of the neural network; F(θ, x) may represent the prediction classification result; y may represent the initial category tag; ŷ may represent the corrected category tag; L(F(θ, x), y) may represent the first loss; L(F(θ, x) ŷ) may represent the second loss; and α may represent the weight of the second loss.

In this way, the first loss and the second loss may be respectively determined according to the initial category tag and the corrected category tag, so that the overall loss of the neural network is determined, and thus the co-supervision of two supervision signals is realized, and the training effect of the network is improved.

FIG. 2 is a schematic diagram of an application example of a neural network training method according to embodiments of the present disclosure. As shown in FIG. 2, the application example may be divided into two parts, i.e., a training stage 21 and a tag correction stage 22.

In the application example, the target image x may include a plurality of sample images of one training batch. In any one middle state (such as the i^{th} state) in the process of training the neural network, for the training stage 21, the target image x may be inputted to the feature extraction network 211 (including a plurality of convolutional layers) for processing so as to output a first feature of the target image x. The first feature is inputted to the classification network 212 (including the fully-connected layer and the softmax layer) for processing so as to output the predication classification result 213 (F(θ,x)) of the target image x. The first loss L(F(θ, x), y) may be determined according to the predication classification result 213 and the initial category tag y. The second loss L(F(θ,x) ŷ) may be determined according to the predication classification result 213 and the corrected category tag ŷ. Weighted addition is performed on the first loss and the second loss according to the weights 1−α and α to obtain the overall loss Lₜₒₜₐₗ.

In the application example, for the tag correction stage 22, the feature extraction network 211 in the state may be reused or the network parameter of the feature extraction network 211 in the state may be copied to obtain the feature extraction network 221 of the tag correction stage 22. The M sample images 222 (such as the plurality of sample images of the category “trousers” in FIG. 2) are randomly selected from the sample images of the k^{th} category in the training set, and the selected M sample images 222 are respectively inputted to the feature extraction network 221 for processing so as to output the feature set of the selected sample images of the k^{th} category. In this way, the sample image may be randomly selected from the sample images of all the K categories to obtain the feature set 223 including the selected sample images of the K categories.

In the application example, the clustering processing may be respectively performed on the feature set of the selected sample images of each category, and the class prototype feature is selected according to a clustering result. For example, the feature corresponding to the class center is determined as the class prototype feature, or p class prototype features are selected according to a preset rule. In this way, the class prototype feature 224 of each category may be obtained.

In the application example, the target image x may be inputted to the feature extraction network 221 for processing so as to output the first feature G(x) of the target image x, and the first feature obtained in the training stage 21 may also be directly invoked. Then, the feature similarity between the first feature G(x) of the target image x and the class prototype feature of each category is respectively calculated. The category of the class prototype feature corresponding to the maximum value of the feature similarity is determined as the corrected category tag ŷ of the target image x, and thus the process of tag correction is completed. The corrected category tag ŷ may be inputted to the training stage 21 as the additional supervision signal of the training stage.

In the application example, for the training stage 21, after the overall loss Lₜₒₜₐₗ is determined according to the predication classification result 213, the initial category tag y, and the corrected category tag ŷ, the network parameter of the neural network may be reversely adjusted according to the overall loss so as to obtain the neural network of the next state.

The foregoing training stage and the tag correction stage are performed alternately until the network is trained to convergence to obtain the trained neural network.

According to the neural network training method of the embodiments of the present disclosure, a self-correction stage is added to the network training process so as to realize the re-correction of a noise data tag, and the corrected tag is used as a part of the supervision signal, and supervises the training process of the network in combination with an original noise tag, and therefore, the generalization capability of the neural network may be improved after being learned in a non-precisely annotated dataset.

According to the embodiments of the present disclosure, the prototype features of a plurality of categories may be extracted without assuming the noise distribution in advance, the additional supervision data and an auxiliary network, so as to better express the data distribution in the category, the problem that the current network training is difficult in a real noise dataset is solved by means of an end-to-end self-learning framework, and the training process and network design are simplified. According to the embodiments of the present disclosure, the present disclosure may be applied in the field of computer vision, etc., thereby realizing model training in noise data.

According to the embodiments of the present disclosure, also provided is an image processing method, including: inputting an image to be processed into a neural network for classification processing to obtain an image classification result, where the neural network includes a neural network that is obtained by training according to the foregoing method. In this way, high-performance image processing may be realized in a small-scale single network.

It is understood that the forgoing method embodiments in the present disclosure may be combined with each other to form the combined embodiments, without departing from the principle of logic, and details are not described herein again due to space limitation. A person skilled in the art may understand that in the foregoing methods of the specific implementations, the specific order of executing the steps should be determined according to the functions and possible internal logics thereof

In addition, the present disclosure further provides a neural network training apparatus, an image processing apparatus, an electronic device, a computer readable storage medium, and a program, which may all be used to implement any neural network training method and the image processing method provided by the present disclosure. For the corresponding technical solutions and descriptions, please refer to the corresponding contents in the method section. Details are not described again.

FIG. 3 is a block diagram of a neural network training apparatus according to embodiments of the present disclosure. According to another aspect of the present disclosure, a neural network training apparatus is provided. As shown in FIG. 3, the neural network training apparatus includes: a prediction classification module 31, configured to perform classification processing on a target image in a training set by means of a neural network to obtain a prediction classification result of the target image; and a network training module 32, configured to train the neural network according to the prediction classification result, and an initial category tag and a corrected category tag of the target image.

In one possible implementation, the neural network includes a feature extraction network and a classification network. The neural network includes N training states, and N is an integer greater than 1. The prediction classification module includes: a feature extraction submodule, configured to perform feature extraction on the target image by means of the feature extraction network of the i^{th} state to obtain a first feature of the i^{th} state of the target image, where the i^{th} state is one of the N training states, and 0≤i<N; and a result determination submodule, configured to perform classification on the first feature of the i^{th} state of the target image by means of the classification network of the i^{th} state to obtain a prediction classification result of the i^{th} state of the target image.

In one possible implementation, the network training module includes: a loss determination module, configured to determine an overall loss of the i^{th} state of the neural network according to the prediction classification result of the i^{th} state, the initial category tag of the target image, and the corrected category tag of the i^{th} state of the target image; and a parameter adjustment module, configured to adjust a network parameter of the neural network of the i^{th} state according to the overall loss of the i^{th} state to obtain the neural network of a (i+1)^{th} state.

In one possible implementation, the apparatus further includes: a sample feature extraction module, configured to perform feature extraction on a plurality of sample images of a k^{th} category in the training set by means of the feature extraction network of the i^{th} state to obtain a second feature of the i^{th} state of the plurality of sample images, where the k^{th} category is one of K categories of the sample images in the training set, and K is an integer greater than 1; a clustering module, configured to perform clustering processing on the second feature of the i^{th} state of the plurality of sample images of the k^{th} category, and determine a class prototype feature of the i^{th} state of the k^{th} category; and a tag determination module, configured to determine the corrected category tag of the i^{th} state of the target image according to the class prototype feature of the i^{th} state of the K categories and the first feature of the i^{th} state of the target image.

In one possible implementation, the tag determination module includes: a similarity acquisition submodule, configured to respectively acquire a first feature similarity between the first feature of the i^{th} state of the target image and the class prototype feature of the i^{th} state of the K categories; and a tag determination submodule, configured to determine the corrected category tag of the i^{th} state of the target image according to the category to which the class prototype feature corresponding to a maximum value of the first feature similarity belongs.

In one possible implementation, the class prototype feature of the i^{th} state of each category includes a plurality of class prototype features, where the similarity acquisition submodule is configured to: acquire a second feature similarity between the first feature of the i^{th} state and the plurality of class prototype features of the i^{th} state of the k^{th} category; and determine the first feature similarity between the first feature of the i^{th} state and the class prototype feature of the i^{th} state of the k^{th} category according to the second feature similarity.

In one possible implementation, the class prototype feature of the i^{th} state of the k^{th} category includes a class center of the second feature of the i^{th} state of the plurality of sample images of the k^{th} category.

In one possible implementation, the loss determination module includes: a first loss determination submodule, configured to determine a first loss of the i^{th} state of the neural network according to the prediction classification result of the i^{th} state and the initial category tag of the target image; a second loss determination submodule, configured to determine a second loss of the i^{th} state of the neural network according to the prediction classification result of the i^{th} state and the corrected category tag of the i^{th} state of the target image; and an overall loss determination submodule, configured to determine the overall loss of the i^{th} state of the neural network according to the first loss of the i^{th} state and the second loss of the i^{th} state.

According to another aspect of the present disclosure, provided is an image processing apparatus, including: an image classification module, configured to input an image to be processed into a neural network for classification processing to obtain an image classification result, where the neural network includes a neural network that is obtained by training according to the foregoing apparatus.

In some embodiments, the functions provided by or the modules included in the apparatus provided by the embodiments of the present disclosure may be used to implement the methods described in the foregoing method embodiments. For specific implementations, reference may be made to the description in the method embodiments above. For the purpose of brevity, detailed are not described herein again.

The embodiments of the present disclosure further provide a computer readable storage medium having a computer program instruction stored thereon, where when the computer program instruction is executed by the processor, the foregoing method is implemented. The computer readable storage medium may be a nonvolatile computer readable storage medium or a volatile computer readable storage medium.

The embodiments of the present disclosure further provide an electronic device, including: a processor, and a memory configured to store a processor-executable instruction, where the processor is configured to invoke the instruction stored by the memory so as to execute the foregoing method.

The embodiments of the present disclosure further provide a computer program, including a computer readable code, where when the computer readable code is run in the electronic device, the processor in the electronic device executes the foregoing method.

The electronic device may be provided as a terminal, a server, or devices in other forms.

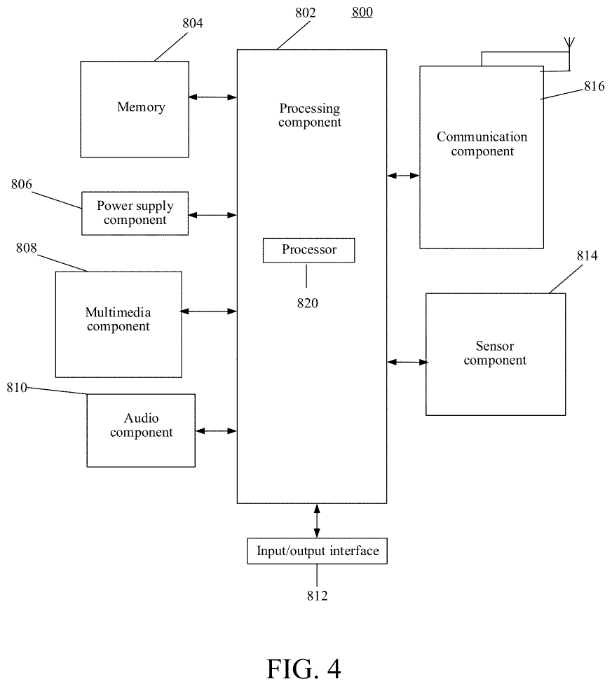

FIG. 4 is a block diagram of an electronic device 800 according to embodiments of the present disclosure. For example, the electronic device 800 may be a terminal such as a mobile phone, a computer, a digital broadcast terminal, a message transceiver device, a game console, a tablet device, a medical device, exercise equipment, and a PDA.

Referring to FIG. 4, the electronic device 800 may include one or more of the following components: a processing component 802, a memory 804, a power supply component 806, a multimedia component 808, an audio component 810, an Input/Output (I/O) interface 812, a sensor component 814, and a communications component 816.

The processing component 802 generally controls overall operation of the electronic device 800, such as operations associated with display, phone calls, data communications, camera operations, and recording operations. The processing component 802 may include one or more processors 820 to execute instructions, to complete all or some of the steps of the foregoing method. In addition, the processing component 802 may include one or more modules, for convenience of interaction between the processing component 802 and other components. For example, the processing component 802 may include a multimedia module, for convenience of interaction between the multimedia component 808 and the processing component 802.

The memory 804 is configured to store various types of data to support operations on the electronic device 800. Examples of the data include instructions for any application or method operated on the electronic device 800, contact data, contact list data, messages, pictures, videos, and the like. The memory 804 may be implemented by any type of volatile or nonvolatile storage device or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk or an optical disk.

The power supply component 806 provides power for various components of the electronic device 800. The power supply component 806 may include a power management system, one or more power supplies, and other components associated with the generation, management, and distribution for the electronic device 800.

The multimedia component 808 includes a screen between the electronic device 800 and a user that provides an output interface. In some embodiments, the screen may include a Liquid Crystal Display (LCD) and a Touch Panel (TP). If the screen includes the TP, the screen may be implemented as a touchscreen, to receive an input signal from the user. The TP includes one or more touch sensors to sense a touch, a slide, and a gesture on the TP. The touch sensor may not only sense a boundary of a touch or slide operation, but also detect duration and pressure related to the touch or slide operation. In some embodiments, the multimedia component 808 includes a front-facing camera and/or a rear-facing camera. When the electronic device 800 is in an operation mode, for example, a photography mode or a video mode, the front-facing camera and/or the rear-facing camera may receive external multimedia data. Each front-facing camera or rear-facing camera may be a fixed optical lens system that has a focal length and an optical zoom capability.

The audio component 810 is configured to output and/or input an audio signal. For example, the audio component 810 includes a microphone (MIC) configured to receive an external audio signal when the electronic device 800 is in an operation mode, such as a calling mode, a recording mode, and a voice recognition mode. The received audio signal may be further stored in the memory 804 or sent by using the communication component 816. In some embodiments, the audio component 810 further includes a loudspeaker, configured to output an audio signal.

The I/O interface 812 provides an interface between the processing component 802 and a peripheral interface module, and the peripheral interface module may be a keyboard, a click wheel, a button, and the like. These buttons may include, but are not limited to, a home button, a volume button, a startup button, and a lock button.

The sensor component 814 includes one or more sensors for providing state assessment in various aspects of the electronic device 800. For instance, the sensor component 814 may detect an on/off state of the electronic device 800, and relative positioning of components, which are the display and keypad of the electronic device 800, for example, and the sensor component 814 may further detect a position change of the electronic device 800 or a component of the electronic device 800, the presence or absence of contact of the user with the electronic device 800, the orientation or acceleration/deceleration of the electronic device 800, and a temperature change of the electronic device 800. The sensor component 814 may include a proximity sensor configured to detect the existence of a nearby object when there is no physical contact. The sensor component 814 may further include an optical sensor, such as a CMOS or CCD image sensor, configured for use in imaging applications. In some embodiments, the sensor component 814 may further include an acceleration sensor, a gyroscope sensor, a magnetic sensor, a pressure sensor, or a temperature sensor.

The communication component 816 is configured to facilitate wired or wireless communications between the electronic device 800 and other devices. The electronic device 800 may access a communication-standard-based wireless network, such as Wi-Fi, 2G or 3G, or a combination thereof. In one exemplary embodiment, the communication component 816 receives a broadcast signal or broadcast-related information from an external broadcast management system via a broadcast channel. In one exemplary embodiment, the communication component 816 further includes a Near Field Communication (NFC) module, to facilitate short-range communications. For example, the NFC module is implemented based on a Radio Frequency Identification (RFID) technology, an Infrared Data Association (IrDA) technology, an Ultra-Wideband (UWB) technology, a Bluetooth (BT) technology, and other technologies.

In exemplary embodiments, the electronic device 800 may be implemented by one or more of an Application Specific Integrated Circuit (ASIC), a Digital Signal Processor (DSP), a Digital Signal Processing Device (DSPD), a Programmable Logic Device (PLD), a Field Programmable Gate Array (FPGA), a controller, a microcontroller, a microprocessor, or other electronic components, and is configured to execute the foregoing methods.

In exemplary embodiments, a nonvolatile computer readable storage medium, for example, the memory 804 including the computer program instruction, is further provided. The foregoing computer program instruction may be executed by the processor 820 of the electronic device 800 to complete the foregoing method.

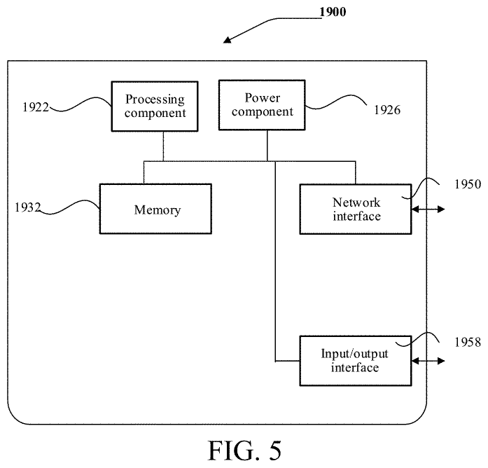

FIG. 5 is a block diagram of an electronic device 1900 according to embodiments of the present disclosure. For example, the electronic device 1900 may be provided as a server. Referring to FIG. 5, the electronic device 1900 includes a processing component 1922 which further includes one or more processors, and a memory resource represented by a memory 1932 and configured to store instructions executable by the processing component 1922, for example, an application program. The application program stored in the memory 1932 may include one or more modules, each of which corresponds to a set of instructions. In addition, the processing component 1922 is configured to execute instructions so as to execute the foregoing methods.

The electronic device 1900 may further include a power supply component 1926 configured to execute power management of the electronic device 1900, one wired or wireless network interface 1950 configured to connect the electronic device 1900 to the network, and an I/O interface 1958. The electronic device 1900 may be operated based on an operating system stored in the memory 1932, such as Windows Server™, Mac OS X™, Unix™, Linux™, FreeBSD™, or the like.

In exemplary embodiments, a non-volatile computer-readable storage medium, for example, the memory 1932 including computer program instructions, is further provided. The computer program instructions may be executed by the processing component 1922 of the electronic device 1900 to complete the foregoing method.

The present disclosure may be a system, a method and/or a computer program product. The computer program product may include a computer readable storage medium having computer readable program instructions thereon for causing a processor to implement the aspects of the present disclosure.

The computer readable storage medium may be a tangible device that may maintain and store instructions used by an instruction execution device. The computer readable storage medium may be, but is not limited to, an electronic storage device, a magnetic storage device, an optical storage device, an electromagnetic storage device, a semiconductor storage device, or any suitable combination of the above ones. More specific examples (a non-exhaustive list) of the computer readable storage medium include: a portable computer disk, a hard disk, a Random Access Memory (RAM), the ROM, the EPROM or the Flash memory, the SRAM, a portable Compact Disc Read-Only Memory (CD-ROM), a Digital Versatile Disk (DVD), a memory stick, a floppy disk, a mechanical coding device such as a punched card storing instructions or a protrusion structure in a groove, and any appropriate combination thereof. The computer readable storage medium used here is not interpreted as an instantaneous signal such as a radio wave or another freely propagated electromagnetic wave, an electromagnetic wave propagated by a waveguide or another transmission medium (for example, an optical pulse transmitted by an optical fiber cable), or an electrical signal transmitted by a wire.

The computer readable program instructions described here may be downloaded from a computer readable storage medium to each computing/processing device, or downloaded to an external computer or an external storage device via a network, such as the Internet, a local area network, a wide area network, and/or a wireless network. The network may include a copper transmission cable, optical fiber transmission, wireless transmission, a router, a firewall, a switch, a gateway computer, and/or an edge server. A network adapter or a network interface in each computing/processing device receives the computer readable program instructions from the network, and forwards the computer readable program instructions, so that the computer readable program instructions are stored in a computer readable storage medium in each computing/processing device.

Computer program instructions for carrying out operations of the present disclosure may be assembler instructions, Instruction-Set-Architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may be completely executed on a user computer, partially executed on a user computer, executed as an independent software package, executed partially on a user computer and partially on a remote computer, or completely executed on a remote computer or a server. In the case of a remote computer, the remote computer may be connected to a user computer via any type of network, including a Local Area Network (LAN) or a Wide Area Network (WAN), or may be connected to an external computer (for example, connected via the Internet with the aid of an Internet service provider). In some embodiments, electronic circuitry including, for example, programmable logic circuitry, Field-Programmable Gate Arrays (FPGAs), or Programmable Logic Arrays (PLAs) may execute the computer readable program instructions by utilizing state information of the computer readable program instructions to personalize the electronic circuitry, in order to implement the aspects of the present disclosure.

Aspects of the present disclosure are described herein with reference to flowcharts and/or block diagrams of methods, apparatuses (systems), and computer program products according to the embodiments of the present disclosure. It should be understood that each block of the flowcharts and/or block diagrams and a combinations of the blocks in the flowcharts and/or block diagrams may be implemented by using the computer readable program instructions.

These computer readable program instructions may be provided for a general-purpose computer, a dedicated computer, or a processor of another programmable data processing apparatus to generate a machine, so that when the instructions are executed by the computer or the processor of the another programmable data processing apparatus, an apparatus for implementing a specified function/action in one or more blocks in the flowcharts and/or block diagrams is generated. These computer readable program instructions may also be stored in a computer readable storage medium, and may direct a computer, a programmable data processing apparatus, and/or other devices to function in a particular manner. Therefore, the computer readable storage medium storing the instructions includes an artifact, and the artifact includes instructions for implementing a specified function/action in one or more blocks in the flowcharts and/or block diagrams.

The computer readable program instructions may also be loaded onto a computer, another programmable data processing apparatus, or another device, so that a series of operations and steps are executed on the computer, the another programmable apparatus or the another device, thereby generating a computer-implemented process. Therefore, the instructions executed on the computer, the another programmable apparatus, or the another device implement a specified function/action in one or more blocks in the flowcharts and/or block diagrams.

The flowcharts and block diagrams in the accompanying drawings illustrate the architecture, functionality, and operations of possible implementations of systems, methods, and computer program products according to multiple embodiments of the present disclosure. In this regard, each block in the flowcharts or block diagrams may represent a module, a program segment, or a part of instruction, and the module, the program segment, or the part of instruction includes one or more executable instructions for implementing a specified logical function. In some alternative implementations, the functions marked in the block may also occur in an order different from that marked in the accompanying drawings. For example, two consecutive blocks are actually executed substantially in parallel, or are sometimes executed in a reverse order, depending on the involved functions. It should also be noted that each block in the block diagrams and/or flowcharts and a combination of blocks in the block diagrams and/or flowcharts may be implemented by using a dedicated hardware-based system that executes a specified function or action, or may be implemented by using a combination of dedicated hardware and a computer instruction.

Different embodiments of the present disclosure may be combined with each other, without departing from the logic, the descriptions of different embodiments have different emphases, and reference is made to other embodiments for the part that is not emphasized.

The descriptions of the embodiments of the present disclosure have been presented for purposes of illustration, but are not intended to be exhaustive or limited to the embodiments disclosed. For a person of ordinary skill in the art, many modifications and variations are all obvious without departing from the scope and spirit of the described embodiments. The terms used in the specification are intended to best explain the principles of the embodiments, practical applications, or technical improvements to the technologies in the market, or to enable others of ordinary skill in the art to understand the embodiments disclosed in the specification.

1. A neural network training method, comprising:
performing classification processing on a target image in a training set by means of a neural network to obtain a prediction classification result of the target image; and
training the neural network according to the prediction classification result, and an initial category tag and a corrected category tag of the target image.

2. The method according to claim 1, wherein the neural network comprises a feature extraction network and a classification network, the neural network comprises N training states, and N is an integer greater than 1;
wherein performing classification processing on the target image in the training set by means of the neural network to obtain the prediction classification result of the target image comprises:
performing feature extraction on the target image by means of the feature extraction network of an i^{th} state to obtain a first feature of the i^{th} state of the target image, wherein the i^{th} state is one of the N training states, and 0≤i<N; and
performing classification on the first feature of the i^{th} state of the target image by means of the classification network of the i^{th} state to obtain a prediction classification result of the i^{th} state of the target image.

3. The method according to claim 2, wherein training the neural network according to the prediction classification result, and the initial category tag and the corrected category tag of the target image comprises:
determining an overall loss of the i^{th} state of the neural network according to the prediction classification result of the i^{th} state, the initial category tag of the target image, and the corrected category tag of the i^{th} state of the target image; and
adjusting a network parameter of the neural network of the i^{th} state according to the overall loss of the i^{th} state to obtain the neural network of a (i+1)^{th} state.

4. The method according to claim 2, further comprising:
performing feature extraction on a plurality of sample images of a k^{th} category in the training set by means of the feature extraction network of the i^{th} state to obtain a second feature of the i^{th} state of the plurality of sample images, wherein the k^{th} category is one of K categories of the sample images in the training set, and K is an integer greater than 1;
performing clustering processing on the second feature of the i^{th} state of the plurality of sample images of the k^{th} category, and determining a class prototype feature of the i^{th} state of the k^{th} category; and
determining the corrected category tag of the i^{th} state of the target image according to the class prototype feature of the i^{th} state of the K categories and the first feature of the i^{th} state of the target image.

5. The method according to claim 4, wherein determining the corrected category tag of the i^{th} state of the target image according to the class prototype feature of the i^{th} state of the K categories and the first feature of the i^{th} state of the target image comprises:
respectively acquiring a first feature similarity between the first feature of the i^{th} state of the target image and the class prototype feature of the i^{th} state of the K categories; and
determining the corrected category tag of the i^{th} state of the target image according to the category to which the class prototype feature corresponding to a maximum value of the first feature similarity belongs.

6. The method according to claim 5, wherein the class prototype feature of the i^{th} state of each category comprises a plurality of class prototype features,
wherein respectively acquiring the first feature similarity between the first feature of the i^{th} state of the target image and the class prototype feature of the i^{th} state of the K categories comprises:
acquiring a second feature similarity between the first feature of the i^{th} state and the plurality of class prototype features of the i^{th} state of the k^{th} category; and
determining the first feature similarity between the first feature of the i^{th} state and the class prototype feature of the i^{th} state of the k^{th} category according to the second feature similarity.

7. The method according to claim 4, wherein the class prototype feature of the i^{th} state of the k^{th} category comprises a class center of the second features of the i^{th} state of the plurality of sample images of the k^{th} category.

8. The method according to claim 3, wherein determining the overall loss of the i^{th} state of the neural network according to the prediction classification result of the i^{th} state, the initial category tag of the target image, and the corrected category tag of the i^{th} state of the target image comprises:
determining a first loss of the i^{th} state of the neural network according to the prediction classification result of the i^{th} state and the initial category tag of the target image;
determining a second loss of the i^{th} state of the neural network according to the prediction classification result of the i^{th} state and the corrected category tag of the i^{th} state of the target image; and
determining the overall loss of the i^{th} state of the neural network according to the first loss of the i^{th} state and the second loss of the i^{th} state.

9. An image processing method, comprising:
inputting an image to be processed into a neural network for classification processing to obtain an image classification result,
wherein the neural network comprises a neural network that is obtained by training according to the method of claim 1.

10. A neural network training apparatus, comprising:
a processor; and
a memory configured to store processor-executable instructions,
wherein the processor is configured to invoke the instructions stored in the memory, so as to:
perform classification processing on a target image in a training set by means of a neural network to obtain a prediction classification result of the target image; and
train the neural network according to the prediction classification result, and an initial category tag and a corrected category tag of the target image.

11. The apparatus according to claim 10, wherein the neural network comprises a feature extraction network and a classification network; the neural network comprises N training states, and N is an integer greater than 1;
wherein performing classification processing on the target image in the training set by means of the neural network to obtain the prediction classification result of the target image comprises:
performing feature extraction on the target image by means of the feature extraction network of an i^{th} state to obtain a first feature of the i^{th} state of the target image, wherein the i^{th} state is one of the N training states, and 0≤i<N; and
performing classification on the first feature of the i^{th} state of the target image by means of the classification network of the i^{th} state to obtain a prediction classification result of the i^{th} state of the target image.

12. The apparatus according to claim 11, wherein training the neural network according to the prediction classification result, and the initial category tag and the corrected category tag of the target image comprises:
determining an overall loss of the i^{th} state of the neural network according to the prediction classification result of the i^{th} state, the initial category tag of the target image, and the corrected category tag of the i^{th} state of the target image; and
adjusting a network parameter of the neural network of the i^{th} state according to the overall loss of the i^{th} state to obtain the neural network of a (i+1)^{th} state.

13. The apparatus according to claim 11, wherein the processor is further configured to:
perform feature extraction on a plurality of sample images of a k^{th} category in the training set by means of the feature extraction network of the i^{th} state to obtain a second feature of the i^{th} state of the plurality of sample images, wherein the k^{th} category is one of K categories of the sample images in the training set, and K is an integer greater than 1;
perform clustering processing on the second feature of the i^{th} state of the plurality of sample images of the k^{th} category, and determine a class prototype feature of the i^{th} state of the k^{th} category; and
determine the corrected category tag of the i^{th} state of the target image according to the class prototype feature of the i^{th} state of the K categories and the first feature of the i^{th} state of the target image.

14. The apparatus according to claim 13, wherein determining the corrected category tag of the i^{th} state of the target image according to the class prototype feature of the i^{th} state of the K categories and the first feature of the i^{th} state of the target image comprises:
respectively acquiring a first feature similarity between the first feature of the i^{th} state of the target image and the class prototype feature of the i^{th} state of the K categories; and
determining the corrected category tag of the i^{th} state of the target image according to the category to which the class prototype feature corresponding to a maximum value of the first feature similarity belongs.

15. The apparatus according to claim 14, wherein the class prototype feature of the i^{th} state of each category comprises a plurality of class prototype features,
wherein respectively acquiring the first feature similarity between the first feature of the i^{th} state of the target image and the class prototype feature of the i^{th} state of the K categories comprises:
acquiring a second feature similarity between the first feature of the i^{th} state and the plurality of class prototype features of the i^{th} state of the k^{th} category; and
determining the first feature similarity between the first feature of the i^{th} state and the class prototype feature of the i^{th} state of the k^{th} category according to the second feature similarity.

16. The apparatus according to claim 13, wherein the class prototype feature of the i^{th} state of the k^{th} category comprises a class center of the second features of the i^{th} state of the plurality of sample images of the k^{th} category.

17. The apparatus according to claim 12, wherein determining the overall loss of the i^{th} state of the neural network according to the prediction classification result of the i^{th} state, the initial category tag of the target image, and the corrected category tag of the i^{th} state of the target image comprises:
determining a first loss of the i^{th} state of the neural network according to the prediction classification result of the i^{th} state and the initial category tag of the target image;
determining a second loss of the i^{th} state of the neural network according to the prediction classification result of the i^{th} state and the corrected category tag of the i^{th} state of the target image; and
determining the overall loss of the i^{th} state of the neural network according to the first loss of the i^{th} state and the second loss of the i^{th} state.

18. An image processing apparatus, comprising:
a processor; and
a memory configured to store processor-executable instructions,
wherein the processor is configured to invoke the instructions stored in the memory, so as to:
input an image to be processed into a neural network for classification processing to obtain an image classification result, wherein the neural network comprises a neural network that is obtained by training according to the apparatus of claim 10.

19. A non-transitory computer readable storage medium having a computer program instruction stored thereon, wherein when the computer program instruction is executed by the processor, the processor is caused to perform the operations of:
performing classification processing on a target image in a training set by means of a neural network to obtain a prediction classification result of the target image; and
training the neural network according to the prediction classification result, and an initial category tag and a corrected category tag of the target image.

20. A non-transitory computer readable storage medium having a computer program instruction stored thereon, wherein when the computer program instruction is executed by the processor, the method according to claim 9 is implemented.
